(19) United States
(12) Patent Application Publication
(10) Pub. No.: US 2016/0290519 A1
(43) Pub. Date: Oct. 6, 2016

(54) CHEMICAL INJECTION ASSEMBLY WITH BLEED PORT AND BLEED PLUG

(71) Applicant: TESCOM CORPORATION, Elk River, MN (US)

(72) Inventors: Eric Burgett, McKinney, TX (US); Matthew Whitaker, McKinney, TX (US); Jared B. Chizek, Maple Grove, MN (US)

(21) Appl. No.: 14/691,997

(22) Filed: Apr. 21, 2015

Related U.S. Application Data
(60) Provisional application No. 62/143,756, filed on Apr. 6, 2015.

(51) Int. Cl. F16K 17/02

(52) U.S. Cl. CPC F16K 17/02

(57) ABSTRACT

A chemical injection assembly having a regulator, a metering valve, and an outlet pressure loop. The regulator has a fluid inlet, a fluid outlet, and an outlet pressure port. The metering valve has a valve inlet and a valve outlet, the valve inlet in fluid communication with the fluid outlet of the regulator. The outlet pressure loop is in fluid communication with the valve outlet of the metering valve and has a bleed apparatus positionable in a closed position to seal the bleed apparatus and an open position such that air can be exhausted from the outlet pressure loop through the bleed apparatus.

### CROSS-REFERENCE TO RELATED APPLICATIONS

This application claims priority to U.S. Provisional Patent Application No. 62/143,756, entitled “Chemical Injection Assembly with Bleed Port and Bleed Plug” and filed on Apr. 6, 2015, the entire disclosure of which is hereby incorporated by reference herein.

### FIELD OF THE DISCLOSURE

This disclosure relates generally to chemical injection assemblies and, more particularly, to chemical injection assemblies having a bleed port and bleed plug to allow air trapped within the chemical injection assembly to be exhausted during re-pressurization of the chemical injection assembly.

### BACKGROUND

Process control systems, such as distributed or scalable process control systems like those used in chemical, petroleum or other processes, typically include one or more process controllers communicatively coupled to one or more field devices via analog, digital or combined analog/digital buses. The field devices, which may include, for example, chemical injection assemblies, fluid regulators, control valves, valve positioners, switches and transmitters (e.g., temperature, pressure and flow rate sensors), perform functions within the process such as opening or closing valves and measuring process parameters. The process controller receives signals indicative of process measurements made by the field devices and/or other information pertaining to the field devices, and uses this information to execute or implement one or more control routines to generate control signals, which are sent over the buses to the field devices to control the operation of the process. Information from each of the field devices and the controller is typically made available to one or more applications executed by one or more other hardware devices, such as host or user workstations, personal computers or computing devices, to enable an operator to perform any desired function regarding the process, such as setting parameters for the process, viewing the current state of the process, modifying the operation of the process, etc.

Referring to FIG. 1, an example process control system 10 can be constructed having one or more field devices 15, 16, 17, 18, 19, 20, 21, 22, and 71 in communication with a process controller 11, which in turn, is in communication with a data historian 12 and one or more user workstations 13, each having a display screen 14. So configured, the controller 11 delivers signals to and receives signals from the field devices 15, 16, 17, 18, 19, 20, 21, 22, and 71 and the workstations 13 to control the process control system.

The process controller 11 of the process control system 10 of the version depicted in FIG. 1 is connected via hardwired communication connections to field devices 15, 16, 17, 18, 19, 20, 21, and 22 via input/output (I/O) cards 26 and 28. The data historian 12 may be any desired type of data collection unit having any desired type of memory and any desired or known software, hardware or firmware for storing data. Moreover, while the data historian 12 is illustrated as a separate device in FIG. 1, it may instead or in addition be part of one of the workstations 13 or another computer device, such as a server. The controller 11, which may be, by way of example, a DeltaV™ controller sold by Emerson Process Management, is communicatively connected to the workstations 13 and to the data historian 12 via a communication network 29 which may be, for example, an Ethernet connection.

As mentioned, the controller 11 is illustrated as being communicatively connected to the field devices 15, 16, 17, 18, 19, 20, 21, and 22 using a hardwired communication scheme which may include the use of any desired hardware, software and/or firmware to implement hardwired communications, including, for example, standard 4-20 mA communications, and/or any communications using any smart communication protocol such as the FOUNDATION® Fieldbus communication protocol, the HART® communication protocol, etc. The field devices 15, 16, 17, 18, 19, 20, 21, and 22 may be any types of devices, such as sensors, control valve assemblies, transmitters, positioners, etc., while the I/O cards 26 and 28 may be any types of I/O devices conforming to any desired communication or controller protocol. In the embodiment illustrated in FIG. 1, the field devices 15, 16, 17, 18 are standard 4-20 mA devices that communicate over analog lines to the I/O card 26, while the digital field devices 19, 20, 21, 22 can be smart devices, such as HART® communicating devices and Fieldbus field devices, that communicate over a digital bus to the I/O card 28 using Fieldbus protocol communications. Of course, the field devices 15, 16, 17, 18, 19, 20, 21, and 22 may conform to any other desired standard(s) or protocols, including any standards or protocols developed in the future.

In addition, the process control system 10 depicted in FIG. 1 includes a number of wireless field devices 60, 61, 62, 63, 64 and 71 disposed in the plant to be controlled. The field devices 60, 61, 62, 63, 64 are depicted as transmitters (e.g., process variable sensors) while the field device 71 is depicted as fluid regulating or control unit, such as a chemical injection assembly, including, for example, a fluid regulator and a control valve. Wireless communications may be established between the controller 11 and the field devices 60, 61, 62, 63, 64 and 71 using any desired wireless communication equipment, including hardware, software, firmware, or any combination thereof now known or later developed. In the version illustrated in FIG. 1, an antenna 65 is coupled to and is dedicated to perform wireless communications for the transmitter 60, while a wireless router or other module 66 having an antenna 67 is coupled to collectively handle wireless communications for the transmitters 61, 62, 63, and 64. Likewise, an antenna 72 is coupled to the field device 71 to perform wireless communications for the field device 71. The field devices or associated hardware 60, 61, 62, 63, 64, 66 and 71 may implement protocol stack operations used by an appropriate wireless communication protocol to receive, decode, route, encode and send wireless signals via the antennas 65, 67 and 72 to implement wireless communications between the process controller 11 and the transmitters 60, 61, 62, 63, 64 and the unit 71.

If desired, the transmitters 60, 61, 62, 63, 64 can constitute the sole link between various process sensors (transmitters) and the process controller 11 and, as such, are relied upon to send accurate signals to the controller 11 to ensure that process performance is not compromised. The transmitters 60, 61, 62, 63, 64, often referred to as process variable transmitters (PVTs), therefore may play a significant role in the control of the overall control process. Additionally, the fluid regulating unit 71 may provide measurements made by sensors within the fluid regulating unit 71 or may provide other data generated by or computed by the fluid regulating unit 71 to the controller 11 as part of its operation. Of course, as is known, the fluid regulating unit 71 may also receive control signals from the controller 11 to effect physical parameters, e.g., flow, within the overall process.

The process controller 11 is coupled to one or more I/O devices 73 and 74, each connected to a respective antenna 75 and 76, and these I/O devices and antennas 73, 74, 75, 76 operate as transmitters/receivers to perform wireless communications with the wireless field devices 61, 62, 63, 64 and 71 via one or more wireless communication networks. The wireless communications between the field devices (e.g., the transmitters 60, 61, 62, 63, 64 and the fluid regulating unit 71) may be performed using one or more known wireless communication protocols, such as the WirelessHART® protocol, the Ember protocol, a WiFi protocol, an IEEE wireless standard, etc. Still further, the I/O devices 73 and 74 may implement protocol stack operations used by these communication protocols to receive, decode, route, encode and send wireless signals via the antennas 75 and 76 to implement wireless communications between the controller 11 and the transmitters 60, 61, 62, 63, 64 and the fluid regulating unit 71.

As illustrated in FIG. 1, the controller 11 conventionally includes a processor 77 that implements or oversees one or more process control routines (or any module, block, or sub-routine thereof) stored in a memory 78. The process control routines stored in the memory 78 may include or be associated with control loops being implemented within the process plant. Generally speaking, and as is generally known, the process controller 11 executes one or more control routines and communicates with the field devices 15, 16, 17, 18, 19, 20, 21, 22, 60, 61, 62, 63, 64, and 71, the user workstations 13 and the data historian 12 to control a process in any desired manner(s).

In some cases, a process control system may include a field device such as a chemical injection assembly having two distinct or separate components, a pressure regulator and a control valve (e.g., a metering valve) arranged downstream of and fluidly coupled to the pressure regulator. The pressure regulator regulates the pressure of a fluid flowing therethrough. The control valve is configured to control the flow rate of the regulated fluid after it has passed through the pressure regulator. The control valve then outputs the fluid to a downstream element of the process control system. The control valve may also route the fluid back to the pressure regulator for use as a reference pressure.

For example, as shown in FIG. 2, the field device 71 can be a typical chemical injection assembly 1000 that can consist of a regulator 1100, a metering valve 1200, and an outlet pressure loop 1300. Regulator 1100 can be any fluid regulator that is acceptable for a given application, such as the TESCOM™ 56-2000 Series regulator, and has a fluid inlet 1110, a fluid outlet 1120, and an outlet pressure port 1130. Similarly, metering valve 1200 can be any metering valve that is acceptable for a given application, such as the TESCOM™ VJ Series valve, and has a valve inlet 1210 and a valve outlet 1220. Fluid inlet 1110 of regulator 1100 is in fluid communication with valve inlet 1210 through piping 1400 and connectors 1410, or can be connected using various well known methods. In addition, valve outlet 1220 is in fluid communication with an inlet 1510 of an outlet block 1500 through piping 1400 and connectors 1410, or other various well known methods. Outlet block 1500 also has a first outlet 1520, which can be connected to a downstream piping system (not shown) and a second outlet 1530 connected to and in fluid communication with outlet pressure loop 1300.

In the example shown, outlet pressure loop 1300 interconnects second outlet 1530 of outlet block 1500 and outlet pressure port 1130 of regulator 1100 through a series of pipes 1310, connectors 1320, and joint blocks 1330, 1340, such that the outlet pressure of the fluid at the outlet block 1500 is communicated to an actuator of regulator 1100 to control regulator 1100.

One drawback of typical chemical injection assemblies 1000, such as that shown in FIG. 2, is that during installation or maintenance chemical injection assembly 1000 is depressurized and air can build up in outlet pressure loop 1300. When chemical injection assembly 1000 is then re-pressurized at high injection pressures (e.g., 15,000 psi), the air in outlet pressure loop 1300 can damage chemical injection assembly 1000, such as regulator 1100.

In addition, such an arrangement consumes considerable space and can be difficult and time-consuming to assemble. Moreover, such an arrangement is prone to leakage stemming from, for example, the number of external flow paths that must be set-up between the various components and any variations in those flow paths. Leakage can, in turn, lead to difficulties in maintaining set-point pressure, which can in turn create the need for significant and frequent maintenance and oversight.

### BRIEF SUMMARY OF THE DISCLOSURE

In accordance with one exemplary aspect of the present invention, a chemical injection assembly comprises a regulator, a metering valve, and an outlet pressure loop. The regulator has a fluid inlet, a fluid outlet, and an outlet pressure port. The metering valve has a valve inlet and a valve outlet, the valve inlet in fluid communication with the fluid outlet of the regulator. The outlet pressure loop is in fluid communication with the valve outlet of the metering valve and has a bleed apparatus positionable in a closed position to seal the bleed apparatus and an open position such that air can be exhausted from outlet pressure loop through the bleed apparatus.

In further accordance with any one or more of the foregoing exemplary aspects of the present invention, a chemical injection assembly may further include, in any combination, any one or more of the following preferred forms.

In one preferred from, the bleed apparatus comprises a bleed port and a bleed plug positionable within the bleed port, the bleed plug positionable in a closed position to seal the bleed plug with the bleed port and an open position such that air can be exhausted from the outlet pressure loop through the bleed port.

In another preferred form, the outlet pressure port is in fluid communication with an actuator portion of the regulator.

In another preferred form, the chemical injection assembly further comprises an outlet block having an inlet, a first outlet, and a second outlet, wherein the inlet is in fluid communication with the valve outlet of the metering valve and the second outlet is in fluid communication with the outlet pressure loop.

In another preferred form, the valve outlet of the metering valve is connected to the inlet of the outlet block through piping and at least one connector.

In another preferred form, the fluid outlet of the regulator is connected to the valve inlet of the metering valve through piping and at least one connector.

In another preferred form, the outlet pressure loop comprises a plurality of pipes and a plurality of joint blocks interconnecting the plurality of pipes.

In another preferred form, the bleed apparatus comprises a bleed port and a bleed plug positionable within the bleed port, the bleed plug positionable in a closed position to seal the bleed plug with the bleed port and an open position such that air can be exhausted from the outlet pressure loop through the bleed port.

In another preferred form, the bleed port is formed in one of the plurality of joint blocks.

In another preferred form, the chemical injection assembly further comprises a plurality of connectors connecting the plurality of pipes to the plurality of joint blocks.

In accordance with another exemplary aspect of the present invention, a method of re-pressurizing a chemical injection assembly comprises the steps of: opening a bleed apparatus of an outlet pressure loop of the chemical injection assembly to allow air within the outlet pressure loop to be exhausted from the outlet pressure loop; providing a pressurized operating fluid into the chemical injection assembly; and closing the bleed apparatus once the air has been exhausted from the outlet pressure loop.

In further accordance with any one or more of the foregoing exemplary aspects of the present invention, a method of re-pressurizing a chemical injection assembly may further include, in any combination, any one or more of the following preferred forms.

In one preferred form, the bleed apparatus comprises a bleed port and a bleed plug, opening bleed apparatus includes moving the bleed plug to an open position such that air can be exhausted from the outlet pressure loop through the bleed port, and closing the bleed apparatus includes moving the bleed plug to a closed position to seal the bleed plug with the bleed port.

In another preferred form, the chemical injection assembly comprises a regulator having a fluid inlet, a fluid outlet, and an outlet pressure port, and the pressurized operating fluid is provided into the chemical injection assembly through the fluid inlet of the regulator.

In another preferred form, the outlet pressure port is in fluid communication with an actuator portion of the regulator.

In another preferred form, the chemical injection assembly comprising a metering valve having a valve inlet and a valve outlet, the valve inlet in fluid communication with the fluid outlet of the regulator.

In another preferred form, the outlet pressure loop is in fluid communication with the valve outlet of the metering valve.

In another preferred form, the chemical injection assembly further comprises an outlet block having an inlet, a first outlet, and a second outlet; wherein the inlet is in fluid communication with the valve outlet of the metering valve, and the second outlet is in fluid communication with the outlet pressure loop.

In another preferred form, the outlet pressure loop comprises a plurality of pipes and a plurality of joint blocks interconnecting the plurality of pipes.

In another preferred form, the bleed apparatus comprises a bleed port and a bleed plug positionable within the bleed port, the bleed plug positionable in a closed position to seal the bleed plug with the bleed port and an open position such that air can be exhausted from the outlet pressure loop through the bleed port.

In another preferred form, the bleed port is formed in one of the plurality of joint blocks.

### BRIEF DESCRIPTION OF THE DRAWINGS

FIG. 1 is a schematic representation of an example process control system having a fluid regulating unit constructed in accordance with the principles of the present invention;

FIG. 2 is a side cross-sectional view of a typical chemical injection assembly;

FIG. 3 is a side cross-sectional view of one example of a chemical injection assembly having a bleed port and bleed plug;

FIG. 4 is a side perspective view of the chemical injection assembly of FIG. 3;

FIG. 5 is an enlarged, partial, side, cross-sectional view of one joint block of the chemical injection assembly of FIG. 3;

FIG. 6 is a perspective view of another example of a chemical injection assembly constructed in accordance with the principles of the present invention;

FIG. 7 is a cross-sectional view of the fluid regulating unit of FIG. 6 taken along line 3-3 in FIG. 6;

FIG. 8 is a cross-sectional view of the fluid regulating unit of FIG. 6 taken along line 4-4 in FIG. 6; and

FIG. 9 is a cross-sectional view of a pressure regulator of the fluid regulating unit of FIG. 6.

### DETAILED DESCRIPTION

In the various examples described herein, the chemical injection assemblies have bleed ports and bleed plugs that can be used to remove trapped air in the chemical injection assemblies when initially assembled or when the associated line is depressurized and re-pressurized for service reasons at high injection pressures (e.g., 15,000 psi). Use of a bleed port and bleed plug eliminates the issue of re-pressurization at high injection pressures damaging the chemical injection assemblies or regulators with trapped air (or other wayward gasses), which may have entered the system during service or installation.

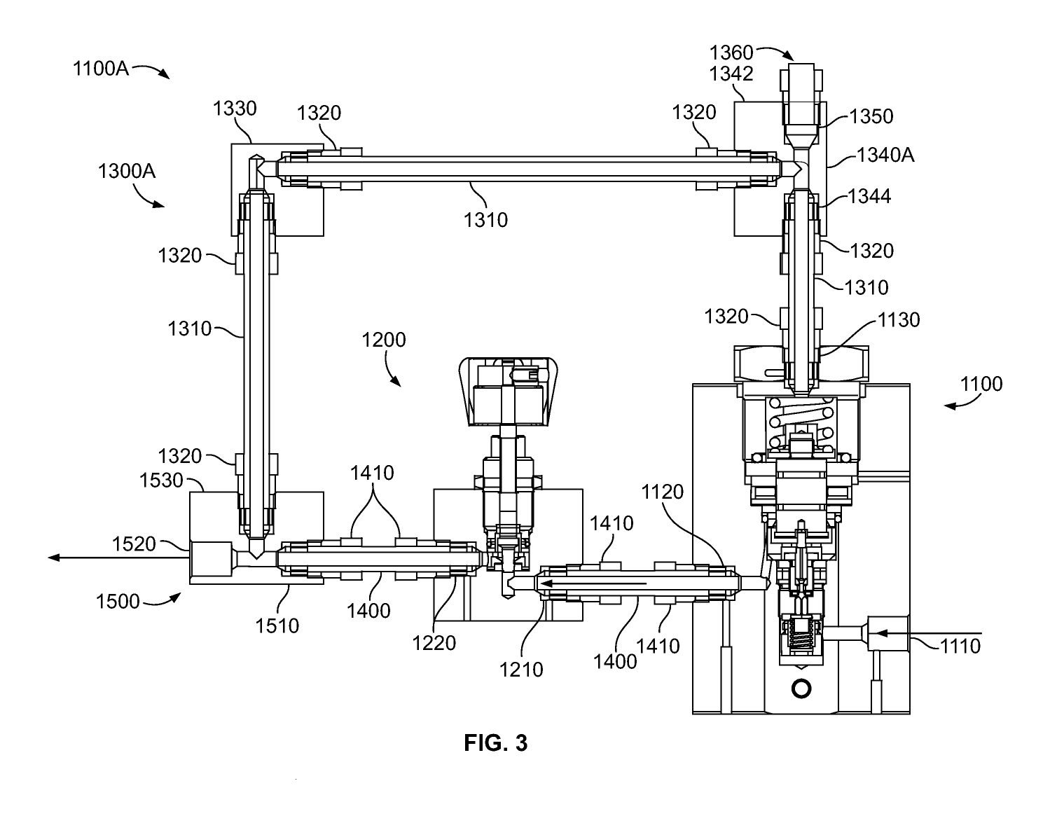

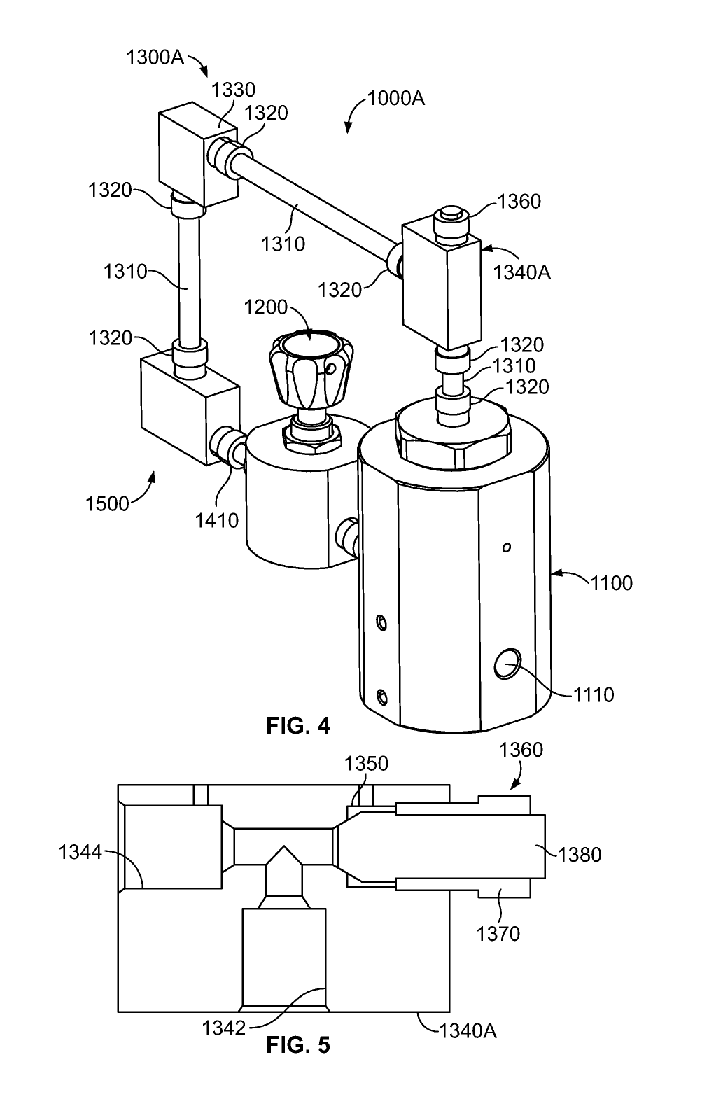

Referring to FIGS. 3-5, one example of a field device 71 in the form of a chemical injection assembly 1000A is shown that can be used to remove trapped air from chemical injection assembly 1000A during re-pressurization, especially at high injection pressures. Chemical injection assembly 1000A is similar to the chemical injection assembly 1000 described above and identical reference numbers are used to identify identical structure. For example, chemical injection assembly 1000A has the same regulator 1100, metering valve 1200, outlet block 1500, piping 1400, and connectors 1410 as described above for chemical injection assembly 1000. One difference is that outlet pressure loop 1300A of chemical injection assembly 1000A includes a bleed apparatus, comprising a bleed port and bleed plug, that can be used to remove trapped air from chemical injection assembly 1000A during re-pressurization. Alternatively, the bleed apparatus could be a valve or any other apparatus that is positionable in a closed position to seal the apparatus and an open position to allow air within outlet pressure loop 1300A.

Outlet pressure loop 1300A interconnects second outlet 1530 of outlet block 1500 and outlet pressure port 1130 of regulator 1100 through a series of pipes 1310, connectors 1320, and joint blocks 1330, 1340A, such that the outlet pressure of the fluid at the outlet block 1500 is communicated to an actuator of regulator 1100 to control regulator 1100. In the example shown, joint block 1340A has an inlet port 1342 to receive outlet fluid from outlet block 1500, an outlet port 1344 in fluid communication with inlet port 1342 through a passage in joint block 1340A to communicate outlet fluid to regulator 1100, and a bleed port 1350 in fluid communication with inlet port 1342 and outlet port 1344 through the passage in joint block 1340A. The inner surface of bleed port 1350 is threaded and adapted to receive bleed plug 1360.

Bleed plug 1360 can be any industry standard plug and, in the example shown, has an outer sleeve 1370 and a plug 1380. Outer sleeve 1370 is generally cylindrical and has an outer surface that is threaded to engage the threaded inner surface of bleed port 1350 and a bore adapted to receive plug 1380. In the example shown, plug 1380 is made of metal for use in high pressure applications and is positioned in the bore in sleeve 1370. Plug 1380 also has a surface, a tapered surface in the example shown, that sealingly engages a surface of bleed port 1350 when bleed plug 1360 is in a closed position.

In the example shown, bleed port 1350 and bleed plug 1360 are shown positioned in joint block 1340A. However, bleed port 1350 and bleed plug 1360 could also be positioned in joint block 1330, in another joint block if additional joint blocks are present in outlet pressure loop 1300A, in pipes 1310 or connectors 1320, or anywhere in outlet pressure loop 1300A, as desired.

In operation, an operating fluid will flow into regulator 1110 through fluid inlet 1110 and flow of the operating fluid through regulator 1110 will be controlled by the positioning of a plug and valve seat within regulator 1110. An actuator portion of regulator 1110 is operatively connected to the plug and moves the plug to position the plug relative to the valve seat to control the flow of the operating fluid. The operating fluid then flow out of regulator 1110 through fluid outlet 1120. Operating fluid from fluid outlet 1120 then flows to valve inlet 1210 of metering valve 1200, through metering valve 1200, and exits through valve outlet 1220. Metering valve 1200 can be used to allow or prevent the flow of the operating fluid through chemical injection assembly 1000A. The operating fluid from valve outlet 1220 of metering valve 1200 then flows to inlet 1510 of outlet block 1500. In outlet block 1500, a portion of the operating fluid will flow out of first outlet 1520 to continue downstream and a portion of the operating fluid will flow out of second outlet 1530 and into outlet pressure loop 1300A. The operating fluid flows through outlet pressure loop 1300A to communicate the pressure of the operating fluid to outlet pressure port 1130 of regulator 1100 through outlet pressure loop 1300A. The pressure of the operating fluid received at outlet pressure port 1130 is then used by the actuator portion of regulator 1100 to move the plug towards or away from the valve seat to regulate the flow of the operating fluid through regulator 1100 based on the outlet pressure of the operating fluid.

When chemical injection assembly 1000A is initially installed or when maintenance is performed, chemical injection assembly 1000A will be depressurized and air can become trapped in chemical injection assembly, such as in outlet pressure loop 1300A. If this air is not exhausted from chemical injection assembly 1000A during re-pressurization, the air can cause damage to chemical injection assembly, such as to regulator 1100. Bleed port 1350 and bleed plug 1360 can be used to eliminate or minimize the amount of trapped air in outlet pressure loop 1300A and, therefore, eliminate or minimize the risk of damage that can occur during re-pressurization. During re-pressurization, bleed plug 1360 can be loosened within bleed port or removed from bleed port 1350 to allow any trapped air to be exhausted from outlet pressure loop. When the trapped air has been exhausted, bleed plug 1360 is then reinserted and/or retightened within bleed port 1350 to again seal bleed port 1350 and return chemical injection assembly 1000A to normal operation.

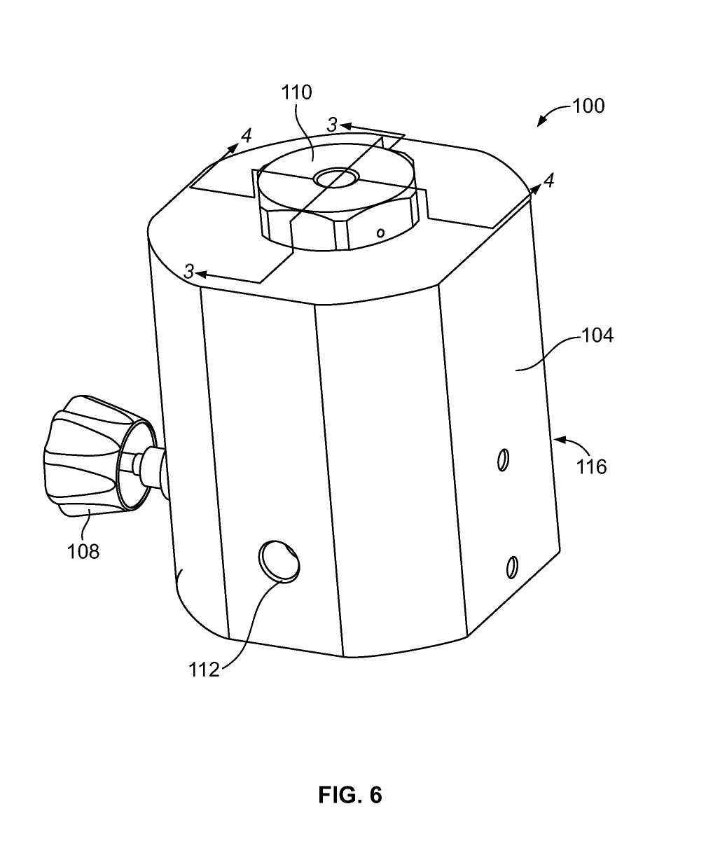

Referring to FIGS. 6-9, another example of a field device 71 in the form of a chemical injection assembly 100 is shown that can be used to remove trapped air from chemical injection assembly 100 during re-pressurization, especially at high injection pressures. The chemical injection assembly 100 integrates or a pressure regulator, a control valve, and a flow path for fluid flowing therethrough into or within a single body. Fluid flowing into the unit is regulated by the pressure regulator and then provided to the control valve. The control valve controls the fluid flow at the desired rate. The fluid flow output from the control valve is then routed back to the pressure regulator for use as a reference pressure. The fluid flow subsequently exits as downstream flow. The fluid regulating unit disclosed herein thus requires little to no assembly, maintains flow control, and, by virtue of having no external plumbing for fluid flow, significantly reduces the potential for leakage.

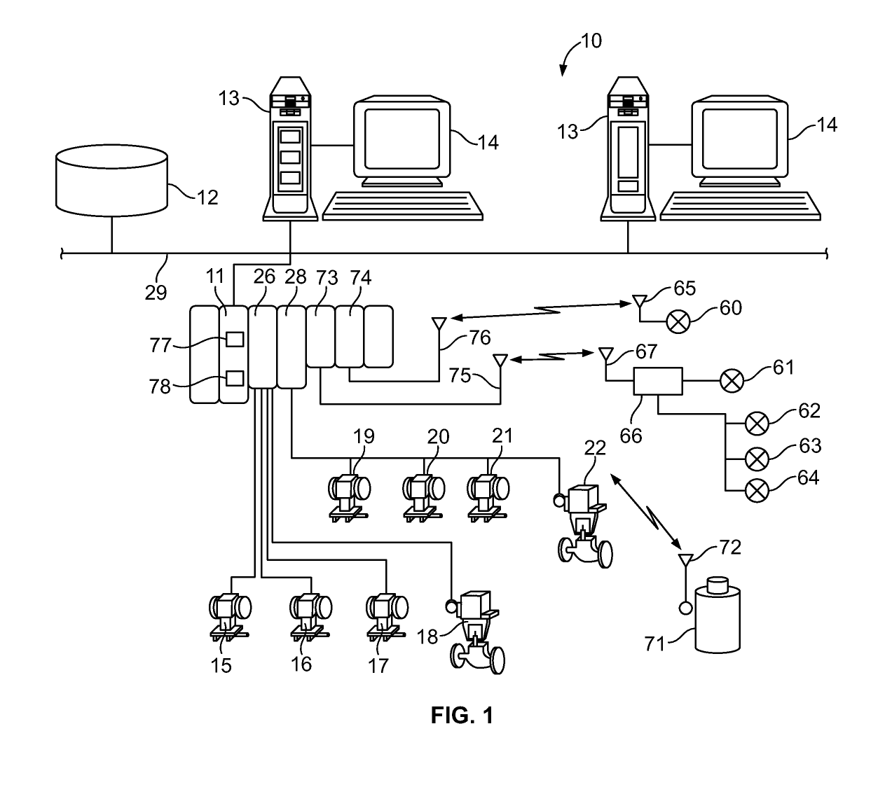

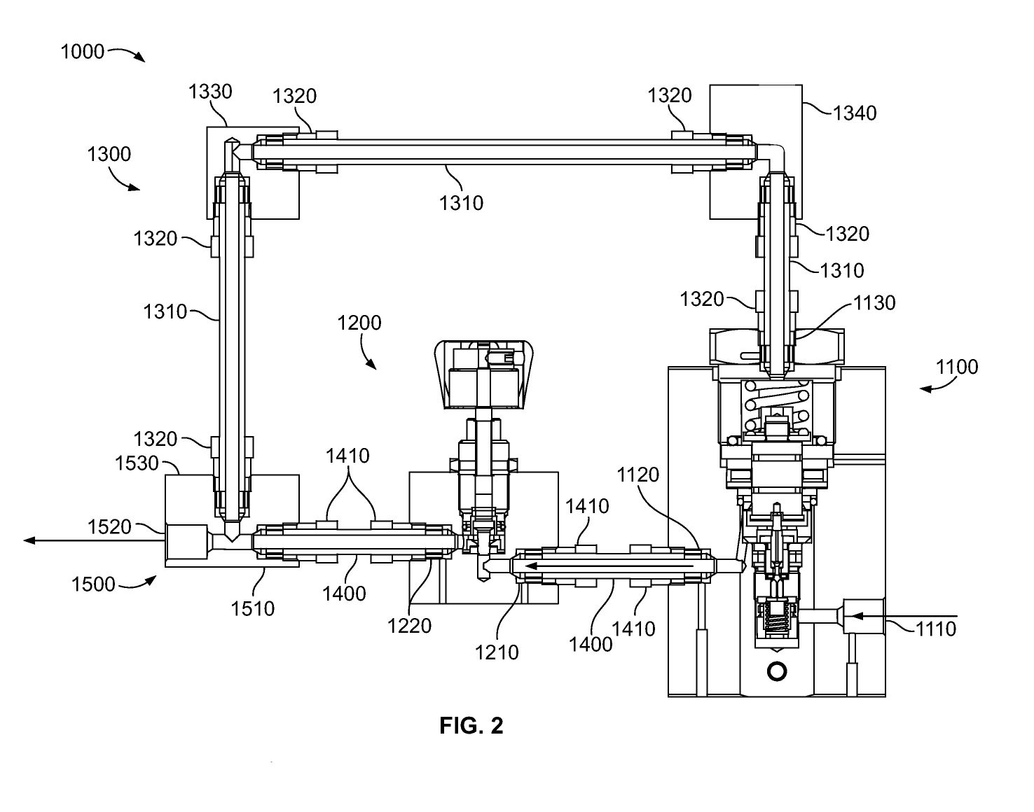

Referring to FIG. 6, for the sake of description, field device 71 from FIG. 1 is shown as a chemical injection assembly 100 constructed in accordance with the principles of the present invention. As shown in FIG. 6, the chemical injection assembly 100 has a single or unitary body 104, a control knob 108 coupled to and extending outwardly from the body 104, and a bonnet 110 movably coupled to a top of the body 104. Further details regarding the control knob 108 and the bonnet 110 will be described below.

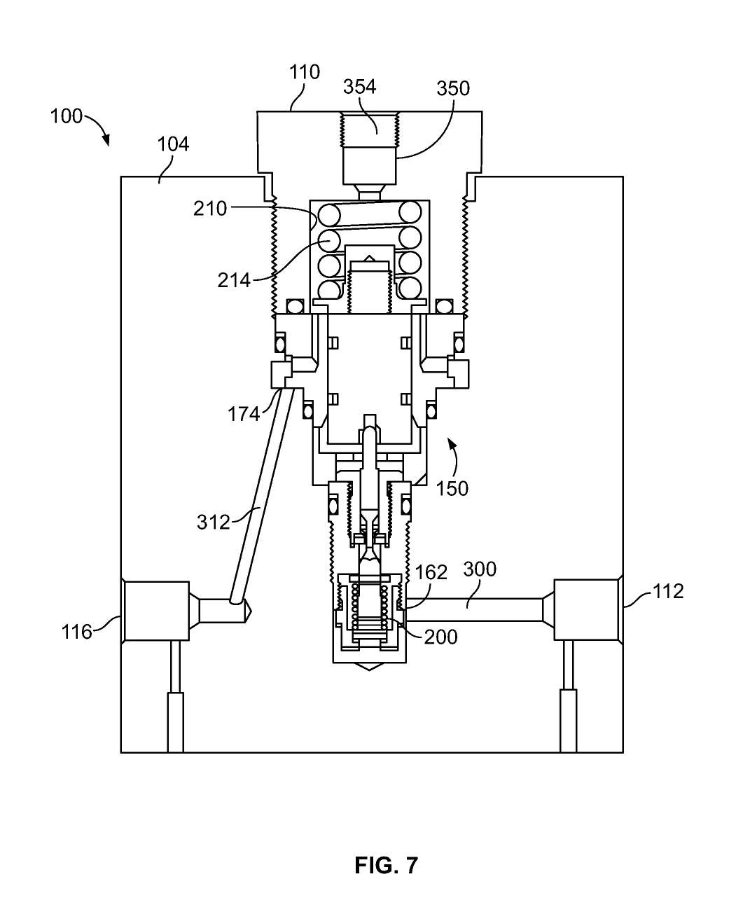

Assembly 100 also has an inlet 112 and an outlet 116 (not visible in FIG. 6, but visible in FIG. 7) defined or formed in opposite portions, respectively, of the body 104. The inlet 112 is configured to receive a flow of fluid from an upstream element (e.g., one of the field devices) of the process control system 10, while the outlet 116 is configured to provide a regulated flow of fluid to a downstream element of the process control system 10.

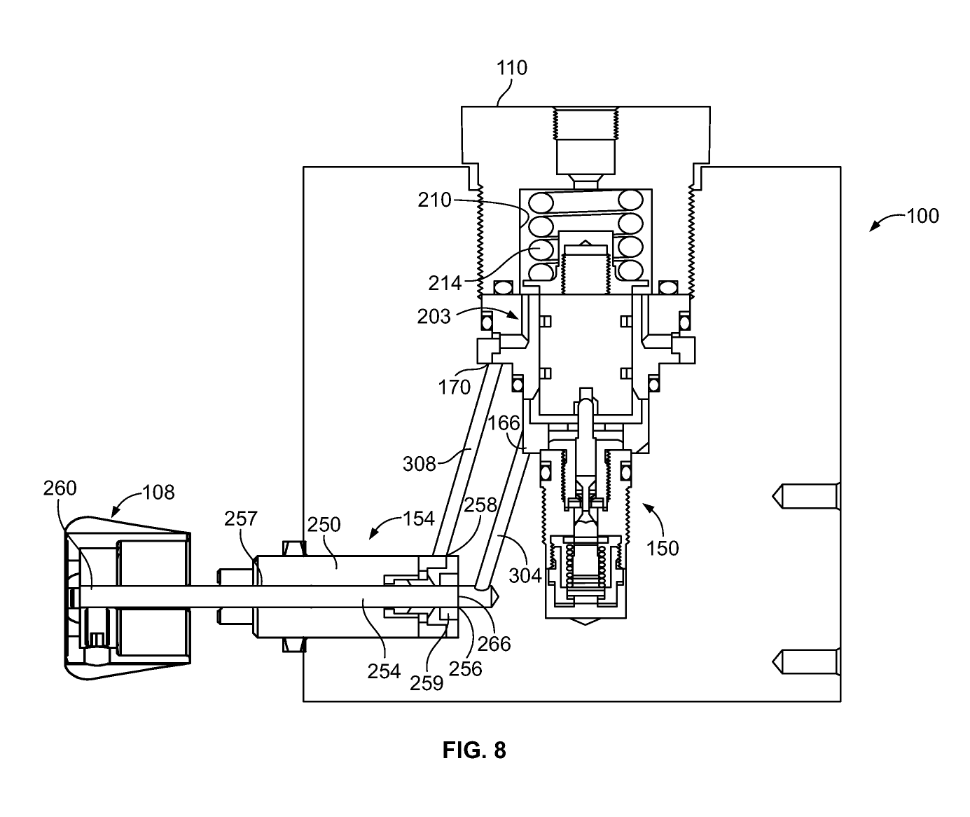

With reference now to FIGS. 7 and 8, the chemical injection assembly 100 generally includes a pressure regulator 150 (e.g., the TESCOM™ 56-2000 Series regulator) and a control valve 154 (e.g., the TESCOM™ VJ Series valve) arranged downstream of the pressure regulator 150. The pressure regulator 150 and the control valve 154 are both integrated into the body 104 of the unit 100. Beneficially, this allows the fluid flow passageways that fluidly connect the inlet 112, the outlet 116, the pressure regulator 150, and the control valve 154 to be arranged internally within the body 104, as will be described in greater detail below.

As illustrated in FIGS. 7-9, the pressure regulator 150 in this example is a dome-loaded pressure regulator that includes a valve body 158 and a control assembly 162. The valve body 158 has a first inlet 162, a first outlet 166, a second inlet 170, and a second outlet 174. As illustrated in FIG. 7, the first inlet 162 is fluidly coupled to the inlet 112 of the body 104, and the second outlet 174 is fluidly coupled to the outlet 116 of the body 104. The first outlet 166 and the second inlet 170 are fluidly coupled to an inlet and an outlet, respectively, of the control valve 154, as will be described in greater detail below.

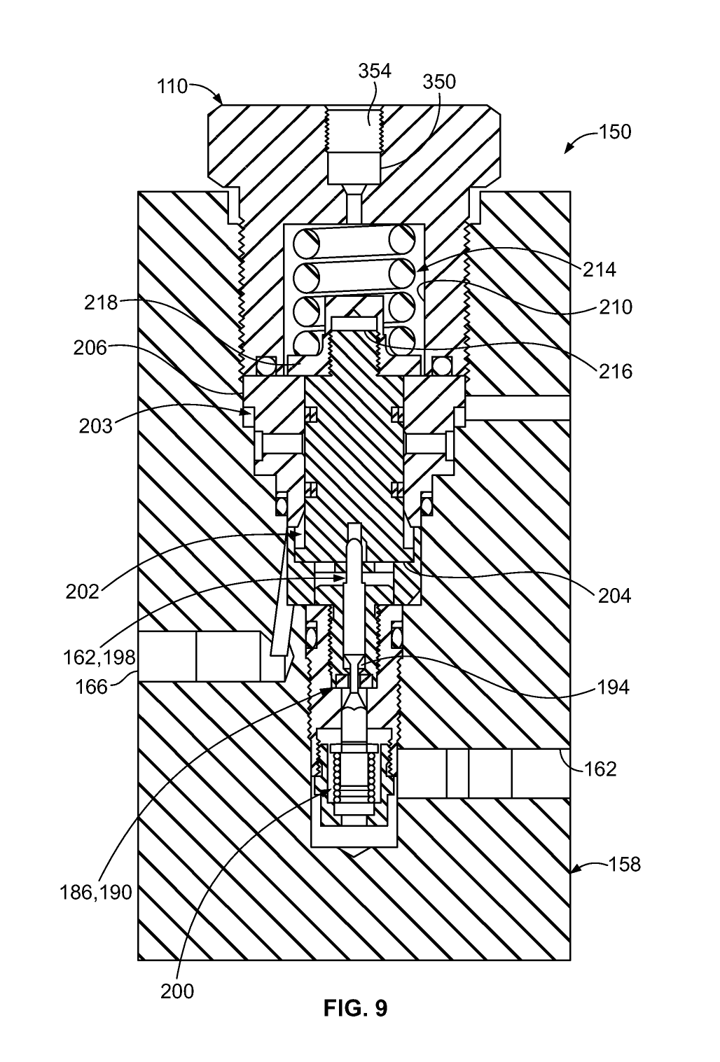

As best seen in FIG. 9, which illustrates the internal components of the pressure regulator 150/1100, the valve body 158 defines a gallery 186 defining a seating surface 190. The control assembly 162 is carried within the valve body 158 and includes a valve connector 194 and a valve stem 198 operatively coupled to the valve connector 194. The valve connector 194 is urged or biased away the seating surface 190 via a spring 200. The valve connector 194 is movable between a closed position in sealing engagement with the seating surface 190 and an open position spaced away from the seating surface 190 in response to pressure changes in the pressure regulator 150, as will be described in greater detail below.

The pressure regulator 150 further includes a primary sensor 202, which in this example takes the form of a piston, slidably engaged within a secondary, or back-up, sensor 203. The secondary sensor 203 is itself slidably engaged within an inner cavity or chamber 206 defined in the valve body 158. A bottom surface 204 of the sensor 202 is in fluid communication with the first outlet 166 of the pressure regulator and receives a portion of the valve stem 198, such that the sensor 202 can move the valve stem 198, and, thus, the valve connector 194 coupled thereto. The bonnet 110 is, in this example, threaded into the body 158; together, the bonnet 110 and the valve body 158 define a control or reference chamber 210. A spring 214 is disposed within the reference chamber 210. The reference chamber 210 is also configured to receive fluid after it has passed through the regulator 150 and the control valve 154, as will be described below. A top surface 216 of the sensor 202 is in fluid communication with the reference chamber 210 via a spring pad 218. The spring 214 and the fluid in the reference chamber 210 together apply a downward force on the spring pad 218, which in turn applies a downward force on the top surface 216, thereby biasing the valve connector 194 against the seating surface 190. The amount of force provided by the spring 214 is set based on a desired pre-set pressure of the fluid assembly 100. If desired, the amount of force applied by the spring 214 can be adjusted by moving (e.g., rotating) the bonnet 110 toward or away from the body 104.

While not explicitly described herein, it will be appreciated that the pressure regulator 150 includes a number of other components, such as, for example, seals (O-rings), back-up rings, and springs. It will also be appreciated that the pressure regulator 150 can have a different shape, size, and/or different components than those illustrated in FIG. 9. As an example, the valve connector 194 can instead take the form of a disc or any other type of control element. As another example, the sensor 202 can take the form of a diaphragm instead of the piston illustrated in FIGS. 7 and 8. In some cases, the regulator 150 need not include the back-up sensor 203.

With reference back to FIGS. 7 and 8, the control valve 154 in this example is a metering valve that includes a body 250 and a control element 254. The body 250 has an inlet 256 and an outlet 258. As illustrated in FIG. 8, the inlet 256 is fluidly coupled to the first outlet 166 of the regulator 150, and the outlet 258 is fluidly coupled to the second inlet 170 of the regulator 150. The control element 254, which in this example is a plug, is movably disposed within a bore 257 of the body 250. The control element 254 is movable relative to an orifice 258 formed within the body 250 to control the rate of fluid flow through the control valve 154. The control element 254 has a first end 262 that is threadingly engaged within the control knob 108. Thus, by actuating the control knob 108, the control valve 154 can be moved between an open position in which a second end 266 of the control element 254 is spaced from the orifice 258, thereby permitting full fluid flow through the valve 154, and a closed position in which the second end 266 of the control element 254 is seated in the orifice 258, thereby blocking fluid flow through the valve 154. Of course, the control valve 154 can be moved to any number of different positions between the open position and the closed position, whereby a limited fluid flow is permitted through the valve 154.

While the control valve 154 illustrated in FIGS. 7 and 8 is a metering valve, the control valve 154 can instead take the form of a shear valve or any other suitable valve. It will also be appreciated that the components of the control valve 154 illustrated in FIGS. 7 and 8 can vary. For example, the body 250 and/or the control element 254 can have a different shape and/or size. If desired, the control element 254 can be actuated differently, for example by coupling the control element 254 to the control knob 108 in a different manner or using a different type of actuator.

Because the pressure regulator 150 and the control valve 154 are integrated into the same body (the body 104 of the assembly 100), the various flow paths necessary for the operation of the assembly 100 can be arranged entirely within the body 104 of the assembly 100. The assembly 100 illustrated in FIGS. 7 and 8 includes four internally arranged or formed passageways—a first passageway 300, a second passageway 304, a third passageway 308, and a fourth passageway 312. The first passageway 300 is formed between and fluidly connects the first inlet 162 of the regulator 150 and the inlet 112 of the body 104. The second passageway 304 is formed between and fluidly connects the first outlet 166 of the regulator 150 and the inlet 256 of the control valve 250. The third passageway 308 is formed between and fluidly connects the outlet 258 of the control valve 250 and the second inlet 170 of the regulator 150. The fourth passageway 312 is formed between and fluidly connects the second outlet 174 of the regulator 150 and the outlet 116 of the body 104.

When the process control system 10 is in operation, fluid can be provided to the assembly 100 from an upstream component of the system 10 via the inlet 112. The fluid is then transferred into the pressure regulator 150, particularly the first inlet 162 of the regulator 150, via the first passageway 300. The pressure regulator 150 regulates the pressure of the fluid based on a desired or set output pressure. Initially, the desired output pressure (i.e., the desired pressure at the first outlet 166) will correspond to the amount of force provided by the spring 214 (i.e., the degree to which the spring 214 biases the sensor 202). Over time, however, the output pressure will correspond to the amount of force provided by the spring 214 as well as the pressure of the fluid in the reference chamber 210 (i.e., the pressure of the fluid after it has passed through the control valve 154). When the pressure at the first inlet 162 is less than the desired output pressure, the sensor 202 is displaced toward the seating surface 190, which thereby moves the valve connector 194 toward the seating surface 190. This movement increases the pressure of the fluid at the first inlet 162. Conversely, when the pressure at the first inlet 162 is greater than the desired output pressure, the sensor 202 is displaced away from the seating surface 190, which thereby moves the valve connector 194 away from the seating surface 190. This movement decreases the pressure of the fluid at the first inlet 162.

The fluid output from the pressure regulator 150 is output at the outlet 166 and transferred from the outlet 166 to the control valve 154, particularly the inlet 258 of valve 154, via the second passageway 304. The control valve 154 subsequently processes the fluid and outputs the fluid at a controlled rate that is based on the position of the control element 254. The fluid output from the control valve 154 is then routed back to the pressure regulator 150 via the third passageway 308. Specifically, the fluid output from the control valve 150 is transferred from the outlet 258 to the second inlet 170 of the pressure regulator 150, which in this example is defined by an opening formed in the back-up sensor 203 disposed in the body of the regulator 150. The fluid, once received at the second inlet 170, is routed to, and flows through, the reference chamber 182. In other words, the outlet pressure is referenced within the dome sensing portion of the pressure regulator 150. This helps to maintain a consistent flow rate at a set inlet pressure. After the fluid flows through the reference chamber 182, the fluid flows out of the pressure regulator 150 via the second outlet 174, which in this example is defined by an opening formed in the back-up sensor 203 at a position opposite the second inlet 170. The fluid is subsequently transferred from the second outlet 174 to the outlet 116 of the assembly 100 via the fourth passageway 312. At this time, the regulated fluid can be provided to a downstream component of the system 10 via the outlet 116.

As also illustrated in FIGS. 7-9, assembly 100 can also include a bleed port 350 formed in the bonnet 110 and a bleed plug 354 removably disposed in the bleed port 350. The inner surface of bleed port 350 is threaded and adapted to receive bleed plug 354. The bleed port 350 and the bleed plug 354 facilitate the removal of air that gets trapped in the assembly 100 when the assembly 100 is initially assembled or when the associated line is depressurized and re-pressurized (e.g., for service reasons) at high injection pressures (e.g., 15,000 psi).

Bleed plug 354 can be any industry standard plug and, in the example shown, is generally cylindrical and has an outer surface that is threaded to engage the threaded inner surface of bleed port 350. In the example shown, bleed plug 354 is made of metal for use in high pressure applications and has a surface, a tapered surface in the example shown, that sealingly engages a surface of bleed port 350 when bleed plug 354 is in a closed position.

While various embodiments have been described above, this disclosure is not intended to be limited thereto. Variations can be made to the disclosed embodiments that are still within the scope of the appended claims.

What is claimed is:

1. A chemical injection assembly, comprising:
a regulator having a fluid inlet, a fluid outlet, and an outlet pressure port;
a metering valve having a valve inlet and a valve outlet, the valve inlet in fluid communication with the fluid outlet of the regulator; and
an outlet pressure loop in fluid communication with the valve outlet of the metering valve, the outlet pressure loop comprising a bleed apparatus positionable in a closed position to seal the bleed apparatus and an open position such that air can be exhausted from outlet pressure loop through the bleed apparatus.

2. The chemical injection assembly of claim 1, wherein the bleed apparatus comprises a bleed port and a bleed plug positionable within the bleed port, the bleed plug positionable in a closed position to seal the bleed plug with the bleed port and an open position such that air can be exhausted from the outlet pressure loop through the bleed port.

3. The chemical injection assembly of claim 1, wherein the outlet pressure port is in fluid communication with an actuator portion of the regulator.

4. The chemical injection assembly of claim 1, further comprising:
an outlet block having an inlet, a first outlet, and a second outlet; wherein
the inlet is in fluid communication with the valve outlet of the metering valve; and
the second outlet is in fluid communication with the outlet pressure loop.

5. The chemical injection assembly of claim 4, wherein the valve outlet of the metering valve is connected to the inlet of the outlet block through piping and at least one connector.

6. The chemical injection assembly of claim 1, wherein the fluid outlet of the regulator is connected to the valve inlet of the metering valve through piping and at least one connector.

7. The chemical injection assembly of claim 1, wherein the outlet pressure loop comprises:
a plurality of pipes; and
a plurality of joint blocks interconnecting the plurality of pipes.

8. The chemical injection assembly of claim 7, wherein the bleed apparatus comprises a bleed port and a bleed plug positionable within the bleed port, the bleed plug positionable in a closed position to seal the bleed plug with the bleed port and an open position such that air can be exhausted from the outlet pressure loop through the bleed port.

9. The chemical injection assembly of claim 8, wherein the bleed port is formed in one of the plurality of joint blocks.

10. The chemical injection assembly of claim 6, further comprising a plurality of connectors connecting the plurality of pipes to the plurality of joint blocks.

11. A method of re-pressurizing a chemical injection assembly, comprising the steps of:
opening a bleed apparatus of an outlet pressure loop of the chemical injection assembly to allow air within the outlet pressure loop to be exhausted from the outlet pressure loop;
providing a pressurized operating fluid into the chemical injection assembly; and
closing the bleed apparatus once the air has been exhausted from the outlet pressure loop.

12. The method of claim 11, wherein:
the bleed apparatus comprises a bleed port and a bleed plug;
opening bleed apparatus includes moving the bleed plug to an open position such that air can be exhausted from the outlet pressure loop through the bleed port; and
closing the bleed apparatus includes moving the bleed plug to a closed position to seal the bleed plug with the bleed port.

13. The method of claim 11, wherein:
the chemical injection assembly comprises a regulator having a fluid inlet, a fluid outlet, and an outlet pressure port; and
the pressurized operating fluid is provided into the chemical injection assembly through the fluid inlet of the regulator.

14. The method of claim 13, wherein the outlet pressure port is in fluid communication with an actuator portion of the regulator.

15. The method of claim 13, further comprising a metering valve having a valve inlet and a valve outlet, the valve inlet in fluid communication with the fluid outlet of the regulator.

16. The method of claim 15, wherein the outlet pressure loop is in fluid communication with the valve outlet of the metering valve.

17. The method of claim 15, further comprising:
an outlet block having an inlet, a first outlet, and a second outlet; wherein
the inlet is in fluid communication with the valve outlet of the metering valve; and
the second outlet is in fluid communication with the outlet pressure loop.

18. The method of claim 11, wherein the outlet pressure loop comprises:
a plurality of pipes; and
a plurality of joint blocks interconnecting the plurality of pipes.

19. The method of claim 18, wherein the bleed apparatus comprises a bleed port and a bleed plug positionable within the bleed port, the bleed plug positionable in a closed position to seal the bleed plug with the bleed port and an open position such that air can be exhausted from the outlet pressure loop through the bleed port.

20. The method of claim 19, wherein the bleed port is formed in one of the plurality of joint blocks.
